(19) United States
(12) Patent Application Publication
(10) Pub. No.: US 2014/0100963 A1
(43) Pub. Date: Apr. 10, 2014

(54) Method, System and Device For Filtering Mobile Terminal Webpage Advertisements

(71) Applicant: Tencent Technology (Shenzhen) Company Limited, Shenzhen (CN)

(72) Inventors: Shudong RUAN, Shenzhen (CN); Kai Zhang, Shenzhen (CN); Yu Xu, Shenzhen (CN)

(73) Assignee: Tencent Technology (Shenzhen) Company Limited, Shenzhen (CN)

(21) Appl. No.: 14/101,886

(22) Filed: Dec. 10, 2013

Related U.S. Application Data
(63) Continuation of application No. PCT/CN2013/081438, filed on Aug. 14, 2013.

(30) Foreign Application Priority Data
Aug. 15, 2012 (CN) 201210290202.5

(51) Int. Cl. G06Q 30/02

(52) U.S. Cl. CPC G06Q 30/0267
USPC 705/14.64

(57) ABSTRACT

The present invention relates to the field of internet technology, which discloses a method, device, server and system for filtering mobile terminal webpage advertisements content. The method includes: a mobile terminal making a request to a server for visiting a website for browsing a webpage via a browser; the server analyzing types of sub-resources data of the webpage, and filtering advertisements content associated with the webpage using filtering rules corresponding to the type of sub-resources data; returning to the mobile terminal, the requested webpage content having the advertisements content been filtered out. The server performs intelligent layout of the sub-resources data on the filtered content of the requested webpage of various websites. By performing advertisement filtering according to the preset filtering rules, download speed is increased and traffic volume is reduced, thus enhances the user experience.

### CROSS-REFERENCE TO RELATED APPLICATIONS

The present application is a continuation out of PCT/CN2013/081438, filed Aug. 14, 2013, which claims priority to Chinese Patent Application No. 201210290202.5, filed Aug. 15, 2012, the entireties of both of which are hereby incorporated by reference.

### FIELD OF THE TECHNOLOGY

The present application relates to the field of internet technologies and, more particularly, to a method, system and device for filtering mobile terminal webpage advertisements.

### BACKGROUND

Currently, World Wide Web (WWW) sites on the internet host various types of webpage advertisements. More specifically, the contents of the various types of webpage advertisements may be broken down to include: pictures, FLASH and Jscript (a type of Windows Script). In certain popular websites, a large amount of advertisements contents may be presented.

For example, when a user launches a browser to browse a webpage, all the contents on the webpage are generally displayed. As the browser downloads the page content, all the advertisement content is downloaded as well, a large amount of advertisement content affects the download speed, wastes the web traffic volume at the same time as well, uses a large amount of memory after having been downloaded to the client side, and affects user browsing speed. It reduces the user reading experience.

To solve this problem, the state of the art sets up a feature for filtering advertisement on some PC (personal computer) browsers, which can filter content from various types of floating window advertisements and pop-up advertisements; some browsers support user uploading of customized advertisement filtering rules and share with other users, but this method does not filter advertisement content to the maximum extent, and is not applicable for filtering advertisements on a mobile terminal.

### SUMMARY

The present invention provides a method, device, server and system for filtering mobile terminal webpage advertisements, which is designed to solve the problem of the inability of the advertisement filtering method in the state of the art for filtering the advertisement content to the maximum extent and the inability thereof for filtering advertisements on the mobile terminal.

An embodiment of the present invention is implemented as a method for filtering mobile terminal webpage advertisements content, which includes a server, performing:

receiving a request from a mobile terminal to visit a website for browsing one or more webpage;

analyzing sub-resource data types of the one or more webpage,

filtering advertisements content associated with the one or more webpage, using filtering rules which correspond to the sub-resource data types; and

returning sub-resource data of the one or more webpage without the associated advertisements content to the mobile terminal for browsing.

The technical solution for the embodiment of the present invention also includes:

determining whether the associated advertisements content needs to be filtered out: if yes, analyzing the sub-resource data types of the one or more webpage and performing the filtering; if no, returning the sub-resource data of the one or more webpage together with the associated advertisements content to the mobile terminal for browsing, and terminating the filtering.

The technical solution for the embodiment of the present invention also includes:

fetching the one or more webpage from a third party server, in response to receiving the request from the mobile terminal to visit the website for browsing the one or more webpage; acquiring the sub-resource data from the one or more webpage via the analyzing; and determining whether the advertisements content associated with the one or more webpage is present or not: if yes, analyzing the sub-resource data type; if no, returning the sub-resource data from the one or more webpage together with a uniform resource locator (URL) list of the advertisements content associated with the one or more webpage to the mobile terminal, and terminating the filtering.

The technical solution for the embodiment of the present invention after the filtering of the advertisements content using the filtering rules, also includes: performing intelligent layout of the sub-resource data in the one or more webpage.

The technical solution for the embodiment of the present invention following the returning of the sub-resource data of the one or more webpage to the mobile terminal, also includes: returning a URL list of the sub-resource data of the one or more webpage along the URL list of the advertisements content associated with the one or more webpage to the mobile terminal; in response, receiving a batch request from the mobile terminal to download the only the URL list of the sub-resource data of the one or more webpage; integrating the URL list of the sub-resource data as one or more webpage content; and returning the one or more webpage content to the mobile terminal for browsing.

The technical solution for the embodiment of the present invention for the returning of the sub-resource data of the one or more webpage without the associated advertisements content to the mobile terminal, also includes: causing to display by the mobile terminal, one or more webpage content having one or more prompting message which indicates filtered advertisements content; wherein the one or more prompting message enables browsing by the mobile terminal, only the filtered advertisements content as one or more new webpage.

The technical solution for the embodiment of the present invention for the returning of the sub-resource data of the one or more webpage without the associated advertisements content to the mobile terminal, also includes: causing to display by the mobile terminal: a calculation of reduction in traffic volume as a result of the filtering by the server, and a reminder to turn off filtering or turn on filtering in a new logging on.

A technical solution adopted for another embodiment of the present invention is: a device for filtering mobile terminal webpage advertisements content, and it includes: at least a processor, processing functions in conjunction with: a webpage access module, a sub-resource receiving module and an information display module, wherein: the webpage access module sends a request to a server to request for visiting a website and for browsing one or more webpage, the sub-resource receiving module receives from the server, after filtering advertisements content associated with the one or more webpage, a uniform resource locator (URL) list of sub-resource data of the one or more webpage, and requests for batch downloading from the server, the sub-resource data of the one or more webpage in the URL list, and the information display module displays the sub-resource data of the one or more webpage for browsing.

The technical solution for the embodiment of the present invention also includes: the said device for filtering mobile terminal webpage advertisements also includes a filtering decision module, which issues decision on whether the advertisements content associated with the one or more webpage need to be filtered or not, wherein: if do not need to be filtered, the advertisements content associated with the one or more webpage will be returned by the server to the mobile terminal for browsing; if need to be filtered, the advertisements content associated with the one or more webpage will not be returned by the server to the mobile terminal for browsing.

The technical solution adopted for another embodiment of the present invention is: a server for filtering mobile terminal webpage advertisements content, comprises at least a processor, processing functions in conjunction with: a webpage fetching module, an information filtering module and a webpage return module, wherein: the webpage fetching acquisition module, in response to receiving a request from a mobile terminal to browse one or more webpage at a website, fetches the one or more webpage, acquires sub-resource data via analyzing the one or more webpage; the information filtering module analyzes types of the sub-resource data of the one or more webpage, and filters advertisements content associated with the one or more webpage, using filtering rules which correspond to the sub-resource data types; the webpage return module returns the sub-resource data from the one or more webpage together with a uniform resource locator (URL) list of the advertisements content associated with the one or more webpage to the mobile terminal, and in response to receiving a batch request to download the URL list of the sub-resource data from the one or more webpage, integrates the URL list of the sub-resource data as one or more webpage content; and returns the one or more webpage content to the mobile terminal for browsing.

The technical solution for the embodiment of the present invention also includes: a sub-resource determination module, in response to receiving the request from the mobile terminal to browse the one or more webpage at the website, determines whether the advertisements content exists in the one or more webpage; if exists, the advertisements content is filtered via the information filtering module; if does not exists, if advertisement content does not exist in the page resource content, returns the URL list of the sub-resource data from the one or more webpage to mobile terminal via the webpage return module.

The technical solution for the embodiment of the present invention also includes: a webpage layout module and a traffic volume calculation module, wherein: the webpage layout module performs intelligent layout of the one or more webpage after advertisements content filtering, and the traffic volume calculation module calculates traffic volume reduction resulting from the advertisements content filtering, and reminds a user of the mobile terminal via the information display module, to a reminder to turn off filtering or turn on filtering in a new logging on.

The technical solution adopted for another embodiment of the present invention is: a system for filtering mobile terminal webpage advertisements contents, comprises a mobile terminal communicating to a server, wherein: the mobile terminal makes a request to visit a website to browse one or more webpage via the server, makes a decision on whether or not to filter out advertisements content associated with the one or more webpage: if yes, the server analyzes types of sub-resource data of the one or more webpage, filters out the advertisements content associated with the one or more webpage using filtering rules corresponding to the types of the sub-resource data of the one or more webpage, and returns only sub-resource data of the one or more webpage without the advertisement content to the mobile terminal.

The technical solution for the embodiment of the present invention also includes a webpage access module and a filtering decision module: the webpage access module is used to make a request for visiting a website for browsing one or more webpage via the mobile terminal browser; the filtering decision module is used to make a decision on whether or not advertisements contents associated with the one or more webpage need to be filtered out: if yes, the advertisements content associated with the one or more webpage is filtered out via the server; if no the advertisements content associated with the one or more webpage are returned unfiltered to the mobile terminal via the server.

The technical solution for the embodiment of the present invention also includes: a resource receiving module and an information display module, wherein: the resource receiving module is used to receive from the server, the sub-resource data of the one or more webpage, and make a batch request to the server to download the sub-resource data of the one or more webpage in a uniform resource locator (URL) list; and the information display module is used to display: the one or more webpage content having one or more prompting message which indicates filtered advertisements content; wherein the one or more prompting message enables browsing by the mobile terminal, only the filtered advertisements content as one or more new webpage, a calculation of reduction in traffic volume as a result of the filtering by the server, and a reminder to turn off filtering or turn on filtering in a new logging on.

The technical solution for the embodiment of the present invention also includes: an information filtering module, a webpage return module, wherein: the information filtering module is used to analyze types of sub-resource data of the one or more webpage, and filter the advertisements content associated with the one or more webpage using the filtering rules corresponding to the types of the sub-resource data of the one or more webpage; and the webpage return module returns a URL list of the sub-resource data of the one or more webpage to the mobile terminal, and in response to receiving the batch request from the mobile terminal to download the URL list of the sub-resource data of the one or more webpage, integrate the URL list of the sub-resource data as one or more webpage content; and return the one or more webpage content to the mobile terminal for browsing.

The technical solution for the embodiment of the present invention also includes: the said server also includes the page acquisition module and the resource judgment module, the said page acquisition module is used to capture the page, and acquire the page resource content via analysis; the said resource judgment module is used to make judgment on whether or not advertisement content exists in the page resource content, and if yes, the advertisement content is filtered via the information filtration module; if no, the page content is returned via the page return module.

The technical solution for the embodiment of the present invention also includes: a webpage fetching module and a sub-resource determination module, wherein: the webpage fetching module is used to fetch the one or more webpage, and acquire the sub-resource data of the one or more webpage via analysis of content of the one or more webpage; the said sub-resource determination module is used to determine whether or not advertisements content exists in the content of the one or more webpage page: if yes, the advertisement content is filtered out from the content of the one or more webpage page via the information filtering module; if no, the advertisement content associated with the one or more webpage is returned unfiltered via the webpage return module.

The technical solution for the embodiment of the present invention also includes: a webpage layout module and a traffic volume calculation module, wherein: the webpage layout module is used to perform intelligent layout of the one or more webpage after filtering, and the traffic volume calculation module is used to calculate the traffic volume reduction resulting from the filtering, and remind a user of the mobile terminal to turn off filtering or turn on filtering in a new logging on.

The technical solution of the present invention has the following advantages or benefits: by performing intelligent analysis of the type of sub-resources data of the webpage at various websites, and by performing advertisements content filtering using preset filtering rules for the advertisement content, the method, device, server and system in the embodiments of the present invention for filtering mobile terminal webpage advertisements implement maximum filtering of advertisement content, increase download speed and reduce traffic volume. By displaying the filtering prompting message via the mobile terminal, it makes the mobile terminal filtering feature more personalized. By performing intelligent layout on the filtered webpage content via the server, and by calculating the traffic volume reduction resulting from the filtering, the user is reminded of the benefits of speed improvement due to reduced traffic volume, thus accordingly, greatly enhance user experience.

### BRIEF DESCRIPTION OF THE DRAWINGS

The accompanying drawings are included to provide a further understanding of the claims and disclosure, are incorporated in, and constitute a part of this specification. The detailed description and illustrated embodiments described serve to explain the principles defined by the claims.

FIG. 1A is an events sequence diagram illustrating an exemplary method for filtering mobile terminal webpage advertisements content, according to an embodiment of the present invention.

FIG. 1B illustrates an exemplary flow chart for filtering mobile terminal webpage advertisements content, according to an embodiment of the present invention as shown in FIG. 1A.

FIG. 2A illustrates an exemplary webpage content shown on a mobile terminal, prior to filtering the advertisements content, according to an embodiment of the present invention.

FIG. 2B illustrates an exemplary webpage content shown on a mobile terminal, after filtering the advertisements content of FIG. 2A, according to an embodiment of the present invention.

FIG. 2C illustrates an exemplary advertisement content layout shown on a mobile terminal, prior to the filtering, according to an embodiment of the present invention.

FIG. 2D illustrates an exemplary webpage layout shown on a mobile terminal, after the filtering, according to an embodiment of the present invention.

FIG. 3 illustrates an exemplary system for advertisement content filtering, with exemplary structures of a mobile terminal communicating to a proxy server (350), according to an embodiment of the present invention.

### DETAILED DESCRIPTION OF THE EMBODIMENTS

The various embodiments of the present invention are further described in details in combination with attached drawings and embodiments below. It should be understood that the specific embodiments described here are used only to explain the present invention, and are not used to limit the present invention.

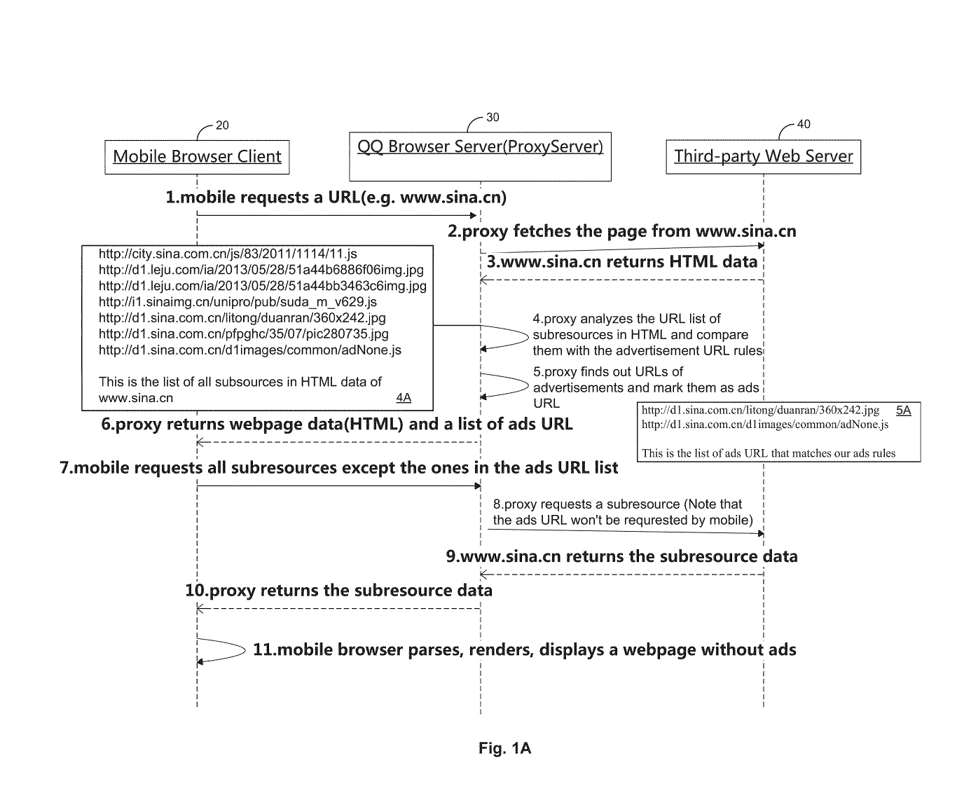

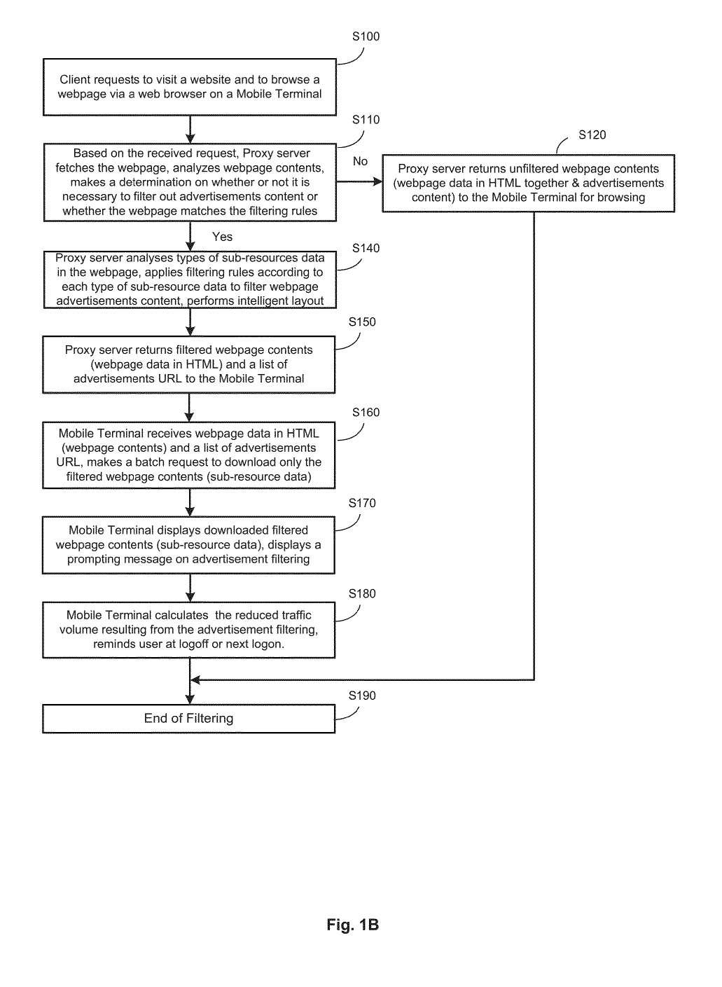

FIG. 1A is an events sequence diagram illustrating an exemplary method for filtering mobile terminal webpage advertisements content, according to an embodiment of the present invention. This embodiment includes a mobile browser client (20), a proxy server (30) (such as a QQ Browser server) and a third party web server (40). The mobile browser client (20) may be a mobile terminal such as a smart phone, a mobile tablet device, a laptop computer or any mobile devices with wireless communication capability to the internet. The third party web server (40) may be a host server which hosts the resources or webpages for the requested websites. The proxy server (20) may act as an intermediary to connect the service requests from the mobile browser client (20) to the requested host (i.e., the third party web server (40)).

An exemplary sequence for filtering mobile terminal webpage advertisements content may include the following steps:

Step 1: The mobile browser client (20) makes a request to a uniform resource locator (URL) on a World Wide Web website (e.g., www.sina.cn).

Step 2: The proxy server (30) in response to receiving the request from the mobile browser client (20), fetches a webpage from the third party web server (40) which hosts the www.sina.cn website.

Step 3: The third party web server (40) may return HTML data (4A) of the www.sina.cn website as webpage content to the proxy server (30). In an embodiment, the webpage content, i.e., HTML data (4A) may include a URL list of sub-resources data pertaining to the www.sina.cn website, and URLs of advertisement content associated with the www.sina.cn website.

For example, the HTML data (4A) may have a URL list with sub-resources data which looks as follows:
http://city.sina.com.cn/js/83/2011/1114/11.js
http://d1.leju.com/ia/2013/05/28/51a44b6886f06img.jpg
http://d1.leju.com/ia/2013/05/28/51a44bb3463c6img.jpg
http://i1.sinaimg.cn/unipro/pub/suda_m_v629.js
http://d1.sina.com.cn/litong/duanran/360×242.jpg
http://d1.sina.com.cn/pfpghc/35/07/pic280735.jpg
http://d1.sina.com.cn/d1images/common/adNone.js

Among which, the URLs of advertisement content (5A) associated with the www.sina.cn website may be included as follows:
http://d1.sina.com.cn/litong/duanran/360×242.jpg
http://d1.sina.com.cn/d1images/common/adNone.js

Step 4: The proxy server (30) may analyze the above HTML data (4A), and compares the HTML data (4A) with preset advertisements URL rules.

Step 5: The proxy server (30) may identify the URLs of advertisement content (5A) from among the HTML data (4A) and mark them as advertisements URLs.

Step 6: The proxy server (30) may return to the mobile browser client (20) the below filtered webpage HTML data (sub-resource data of the webpage):
http://city.sina.com.cn/js/83/2011/1114/11.js
http://d1.leju.com/ia/2013/05/28/51a44b6886f06img.jpg
http://d1.leju.com/ia/2013/05/28/51a44bb3463c6img.jpg
http://i1.sinaimg.cn/unipro/pub/suda_m_v629.js
http://d1.sina.com.cn/pfpghc/35/07/pic280735.jpg

In addition, the proxy server (30) may return to the mobile browser client (20) the list of the advertisements URL (5A) along with the above filtered webpage HTML.

Step 7: In response to receiving the filtered webpage HTML data and the list of the advertisements URL (5A), the mobile browser client (20) may send to the proxy server (30) a request to download only the filtered webpage HTML data (i.e., the sub-resources data of the webpage).

Step 8: Upon receiving the download request from the mobile browser client (20), the proxy server (30) may fetch only the sub-resources data of the webpage from the third party web server (40).

Step 9: The third party web server (40) returns only the sub-resources data of the webpage (i.e., www.sina.cn) to the proxy server (30).

Step 10: The proxy server (30) may forward the fetched sub-resources data of the webpage (i.e., www.sina.cn) to the mobile browser client (20) as filtered webpage content. In an embodiment, the proxy server (30) may perform layout of the filtered webpage content (i.e., sub-resources data of the webpage) prior to forwarding the filtered webpage content to the mobile browser client (20).

Step 11: Upon receiving the downloaded filtered webpage content, the mobile browser client (20) may parse, renders and displays the sub-resources data of the webpage without the advertisements content associated with the website www.sina.cn.

FIG. 1B illustrates an exemplary flow chart for filtering mobile terminal webpage advertisements content, according to an embodiment of the present invention as shown in FIG. 1A.

Step S100: A client may request to visit a website (e.g., www.sina.cn) on a mobile terminal (e.g., mobile browser client (20)). The user may select whether or not advertisements content filtering is needed as a mobile terminal configuration options when sending a visit request. In an embodiment, the request may include a decision to select filtering out advertisements content associated with a webpage at the visited website. Alternately, the request may not include a decision (e.g., default setting) to select filtering out advertisements content associated with a webpage at the visited website.

Step S110: When a user makes a request for visiting a world wide web (WWW) webpage via a browser of the mobile terminal, the request is relayed via a proxy server (e.g., QQ browser server (30)). In an embodiment, the proxy server may fetch the webpage, and analyzes the webpage contents (e.g., sub-resources data), and determines whether or not advertisements contents exists in the webpage contents.

The proxy server may also analyze the visit request to determine if the website visit request includes a request for advertisements content filtering, or whether the advertisements content associated with the webpage matches certain filtering rules.

Step 120: If no (i.e., filtering advertisements is not selected in the website request, or the advertisements content associated with the webpage do not match certain filtering rules), the proxy server may fetch the webpage content and return the unfiltered webpage content (i.e., webpage data in HTML together with the associated advertisements content) to the mobile terminal for browsing.

Step 140: If yes (i.e., filtering advertisements is selected in the website request, or the advertisements content associated with the webpage matches certain filtering rules), filtering configuration is opened in the proxy server and the proxy server may filter the advertisements content of the webpage. The user may not download the filtered advertisements content when browsing, however, relevant prompting text on filtering may be displayed as a prompting message at the mobile terminal.

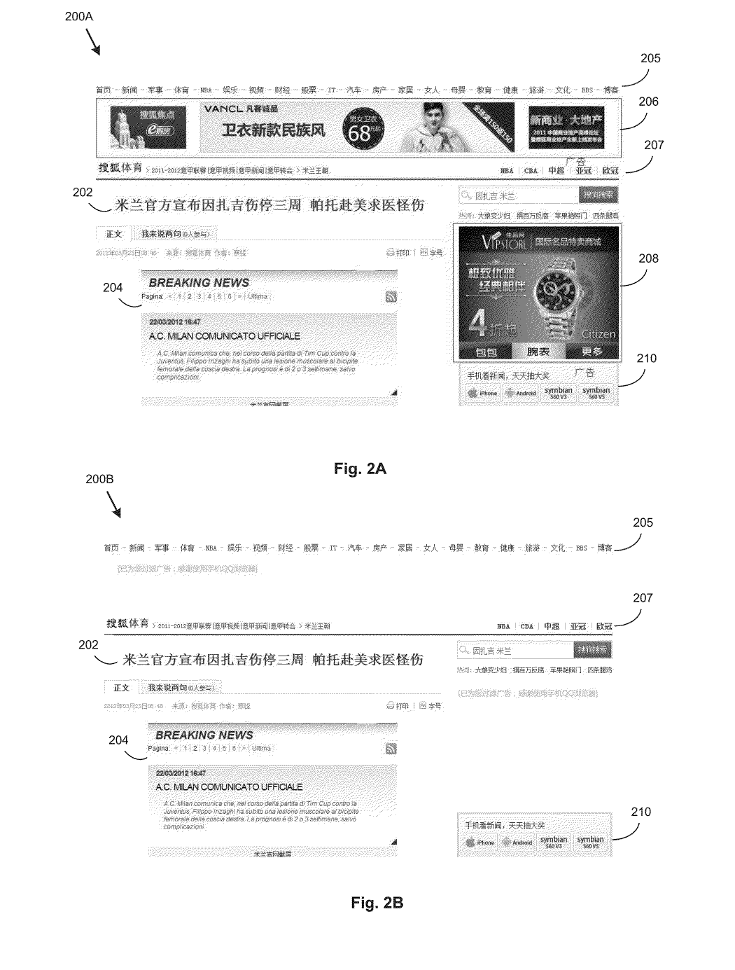

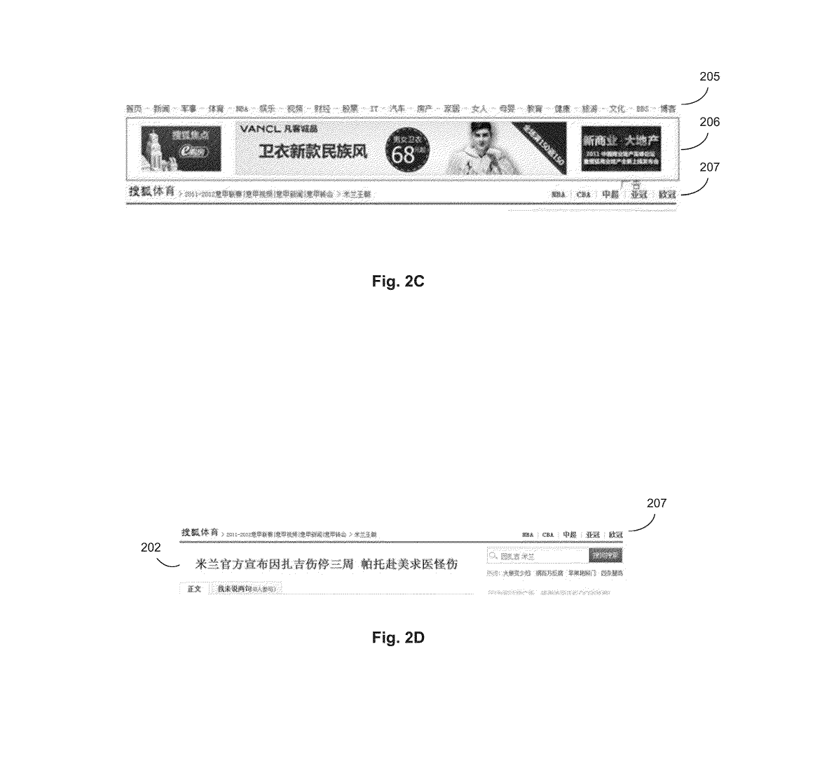

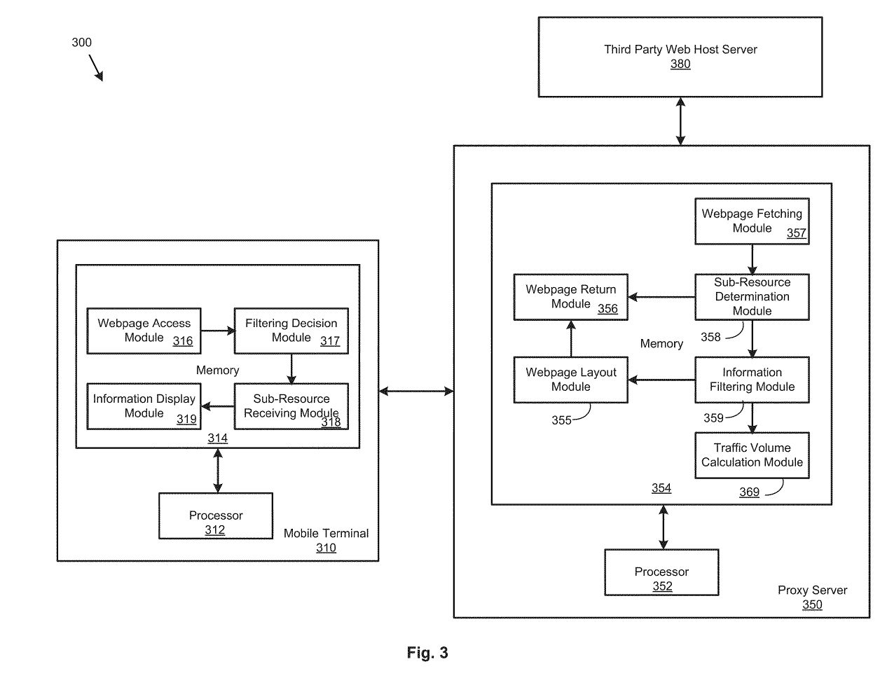

More specifically, the proxy server may analyze each type of webpage contents (e.g., sub-resources data), and may apply filtering rules according to the type of sub-resources data to filter out webpage advertisements content. In an embodiment, the proxy server may perform intelligent layout of the webpage after the filtering. Examples of the analysis, filtering and intelligent layout may be further illustrated in the following FIGS. 2A to 2D.

Step 150: The proxy server may return the filtered webpage contents (webpage data in HTML) and a list of advertisements URL to the mobile terminal.

Step 160: The mobile terminal may receive the webpage data in HTML (i.e., webpage contents) and a list of advertisements URL, and may make a batch request to download only the filtered webpage contents (sub-resources data).

Step 170: The proxy server may integrate or pack the filtered webpage contents (sub-resources data) fetched from a third party web server, and send the filtered webpage contents to the mobile terminal. The mobile terminal may display the downloaded filtered webpage contents.

In an embodiment, the mobile terminal may display a prompting message regarding the filtered advertisements content. The prompting message content may read as “Advertisements have been filtered for you and thank you for using the mobile terminal browser”. In addition, the user can also click the prompting message to view the filtered advertisement content as a new webpage.

Step 180: In an embodiment, the mobile terminal may calculate the reduced traffic volume resulting from the advertisements content filtering, and may remind the user of the filtering setting at logoff or in a next log on.

Step 190: The filtering process is terminated.

FIG. 2A illustrates an exemplary webpage content (200A) shown on a mobile terminal, prior to filtering the advertisements content, according to an embodiment of the present invention.

The unfiltered webpage content (200A) may be a webpage hosted from an exemplary news website such as www.sina.cn. The unfiltered webpage content (200A) may include website heading (205), sports site (207), news download site (210), news headlines (202), breaking news (204) and advertisements content (206, 208).

FIG. 2B illustrates an exemplary layout of the webpage content (200B) on the mobile terminal, after filtering out the advertisements content (206, 208) in FIG. 2A, according to an embodiment of the present invention.

An example below may illustrate exemplary advertisement content filtering rules (performed in the proxy server (350) by an information filtering module (359) in FIG. 3) for the different types of webpage sub-resources data. A pipeline symbol (I) may be used to represent the front end or terminal end of the website for filtering each type of sub-resources data below:
∥cctv.com/Library/a2.js: Indicates that all sub-resources data containing cctv.com/Library/a2.js are to be filtered.

Exceptional rules may be indicated as @@

@@∥img.cnbeta.com/upimg/: Indicates that none of the sub-resources data containing img.cnbeta.com/upimg/ may be filtered

Arbitrary matching may be indicated via *

cnbeta.com/*125image: Both cnbeta.com/23125image and cnbeta.com/vs125image may be filtered.

Regular expression (refers to a singular character string used to describe or match a series of character strings that meet a syntactic rule) may be used to control what to match and what not to match in the filtering rules

{{{/banner/d+/}}: Indicates matchbanner123 may be matched, but banner 321 may not be matched.

In an embodiment, filtering of advertisements content to a maximum extent may be implemented via targeted filtering rules definition for different websites. After filtering, the webpage content may go through an intelligent layout for display on the mobile terminal in order to provide better user's experience.

FIG. 2C illustrates an exemplary layout of advertisement content (206) which may be filtered out between the website heading (205) and the sports site (207), as shown on a mobile terminal, prior to the filtering. In an embodiment, the filtered out advertisement content (206) may be separately viewed via a new webpage upon user's selecting of viewing the prompt message on the mobile terminal.

FIG. 2D illustrates an exemplary layout of the webpage after the filtering, showing only the portions of the sports site (207) and the news headlines (202) on the browser of the mobile terminal.

FIG. 3 illustrates an exemplary system (300) for advertisement content filtering, with exemplary structures of a mobile terminal (310) communicating to a proxy server (350), according to an embodiment of the present invention. The mobile terminal (310) may communicate with a third party web server host via the proxy server (350) by an internet connection.

The mobile terminal (310) may include a processor (312) performing processing the following functions in conjunction with a plurality of modules, namely, a webpage access module (316), a filtering decision module (317), a sub-resources receiving module and an information display module. In an embodiment, the plurality of modules may be implemented as a combination of circuit hardware and software, or as executable software codes stored in a memory (314).

The proxy server (350) may include a processor (352) performing processing functions in conjunction with a plurality of modules, namely, a webpage layout module (355), a webpage return module (356), a webpage fetching module (357), a sub-resource determination module (358), an information filtering module (359), a traffic volume calculation module (369). In an embodiment, the plurality of modules may be implemented as a combination of circuit hardware and software, or as executable software codes stored in a memory (314).

Referring to the mobile terminal (310), the webpage access module (316) may include circuitry and software codes to enable transmission of a request for visiting a website hosted by the third party web server (380) to browse contents of one or more webpage on the website. The filter decision module (317) may include circuitry and software codes which enable a user to decide a configuration on the content of the one or more webpage, whether or not advertisements content associated with the requested one or more webpage should be filtered. If yes, the request may indicate to the proxy server (350) that filtering rules may be applied accordingly to filter out advertisements content. If no, the request may by default, does not include indication to the proxy server (350) to filter out advertisements content, and all advertisements content associated with the webpage may be downloaded unfiltered and to be displayed on the mobile terminal (310) via the proxy server (350).

The sub-resources data module (318) may include circuitry and software codes to enable making a request to download HTML data of the requested webpage, with or without the advertisements content, according to the filtering decision configuration set by the user. The information display module (319) may include circuitry and software codes to enable parsing, rendering and displaying of the downloaded HTML data of the requested webpage, with or without the advertisements content, according to the filtering decision configuration set by the user. The information display module (319) may display a prompting message or text on the webpage regarding the type of advertisements content that have been filtered, and provide a reminder to the user information on reduced traffic volume at user logoff and/or next logon.

Referring to the proxy server (350), the webpage fetching module (357) may include circuitry and software codes, in response to receiving a request to visit a website from the mobile terminal (310), fetches from the third party web server host (380) corresponding webpages according to the requested website.

The sub-resources data determination module (358) may include circuitry and software codes to perform analysis on the types of webpage sub-resources data fetched according to the mobile terminal request.

The information filtering module (359) may include circuitry and software codes to perform filtering functions on the advertisement content in accordance with the filtering rules corresponding to the types of webpage sub-resources data. Examples of the filtering rules have been presented in description of the above FIG. 2B.

The webpage return module (356) may include circuitry and software codes to return HTML data of the webpage including advertisements URLs to the mobile terminal (310). Upon receiving a download batch request for the webpage HTML data only, the webpage fetching module (357) may fetch only the webpage HTML data from the third party web server host (380) and returns only the HTML webpage resource content (i.e., without the advertisements URLs) to the mobile terminal (310) for display and for browsing by the user.

In this regard, when a user makes a request for visiting a WWW page via the webpage access module (316) (e.g., a mobile terminal browser), the request is relayed via the proxy server (350) to the web server host (380). If the user selects an option or configures the mobile terminal (310) to filter out the advertisements content for webpage browsing; the server in response to the request, filters the advertisements content of the requested webpage and returns only the filtered webpage content as HTML data to the mobile terminal (310).

Even though the advertisements content is not downloaded to the mobile terminal (310), nevertheless, the advertisements URLs information is still available to the mobile terminal (310) (see step 6 in FIG. 1A and step 150 in FIG. 1B). A prompting message may be a short message or a text, such as “Advertisements have been filtered for you”, and “thank you for using the mobile terminal browser”, may be displayed on the webpage regarding the filtered advertisements content. The prompting message also enables the user to select an option via a prompting message or prompting text on the displayed webpage, to separately browse only the filtered advertisements via a new webpage (i.e., through action of clicking the prompting message to initiate a separate downloading request for the advertisements content).

As seen, the downloading speed of the webpage on the visited website may be substantially increased by virtue of a reduction of the advertisements content traffic flow through filtering. The filtering of advertisement contents on the mobile terminal enables to enjoy a higher efficiency of the data plan subscription by eliminating unnecessary data traffic to the mobile terminal and therefore reduce the risk of over usage of data allocation for a monthly data plan subscription. Other benefits may include more efficient use of system resources through elimination of unnecessary traffic and undesirable advertisements traffic as a result of the filtering actions.

The foregoing relates to the embodiments of the present invention and shall not be construed as limiting the scope of the invention. Any equivalent structures or process transformations made using the contents of this prospectus and the accompanying drawings, or direct or indirect use of those contents in other related technical fields shall fall within the scope of patent protection of the present invention.

All or part of the operations described above in the embodiments may be implemented via instruction code/program operable to cause relevant hardware to perform the operations, and the program may be stored in a non-transitory computer readable storage medium, such as a ROM/RAM, a magnetic disk, or an optical disk, which are executed in a machine, such as in a mobile terminal, a computer, a laptop, a server, or a third party web hosting server. For example, the invention may be implemented as an algorithm as codes stored in a program module or a system with multi-program-modules.

It will be apparent to those skilled in the art that various modifications and variations can be made to the present disclosure without departing from the scope or spirit of the disclosure. In view of the foregoing, it is intended that the present disclosure cover modifications and variations of this disclosure provided they fall within the scope of the following claims and their equivalents.

1. A method for filtering mobile terminal webpage advertisements content, the method comprising a server, performing:
receiving a request from a mobile terminal to visit a website for browsing one or more webpage;
analyzing sub-resource data types of the one or more webpage,
filtering advertisements content associated with the one or more webpage, using filtering rules which correspond to the sub-resource data types; and
returning sub-resource data of the one or more webpage without the associated advertisements content to the mobile terminal for browsing.

2. The method according to claim 1, wherein in response to receiving the request from the mobile terminal to visit the website for browsing the one or more webpage, comprising:
determining whether the associated advertisements content needs to be filtered out:
if yes, analyzing the sub-resource data types of the one or more webpage and performing the filtering;
if no, returning the sub-resource data of the one or more webpage together with the associated advertisements content to the mobile terminal for browsing, and terminating the filtering.

3. The method according to claim 1, wherein prior to analyzing the sub-resource data types of the one or more webpage, comprising:
fetching the one or more webpage from a third party server, in response to receiving the request from the mobile terminal to visit the website for browsing the one or more webpage;
acquiring the sub-resource data from the one or more webpage via the analyzing; and
determining whether the advertisements content associated with the one or more webpage is present or not:
if yes, analyzing the sub-resource data type;
if no, returning the sub-resource data from the one or more webpage together with a uniform resource locator (URL) list of the advertisements content associated with the one or more webpage to the mobile terminal, and terminating the filtering.

4. The method according to claim 3, wherein after the filtering of the advertisements content using the filtering rules, comprising: performing intelligent layout of the sub-resource data in the one or more webpage.

5. The method according to claim 3, wherein the returning of the sub-resource data of the one or more webpage to the mobile terminal, comprising:
returning a URL list of the sub-resource data of the one or more webpage along the URL list of the advertisements content associated with the one or more webpage to the mobile terminal;
in response, receiving a batch request from the mobile terminal to download the only the URL list of the sub-resource data of the one or more webpage;
integrating the URL list of the sub-resource data as one or more webpage content; and
returning the one or more webpage content to the mobile terminal for browsing.

6. The method according to claim 1, wherein the returning of the sub-resource data of the one or more webpage without the associated advertisements content to the mobile terminal, comprising:
causing to display by the mobile terminal, one or more webpage content having one or more prompting message which indicates filtered advertisements content; wherein the one or more prompting message enables browsing by the mobile terminal, only the filtered advertisements content as one or more new webpage.

7. The method according to claim 6, wherein the returning of the sub-resource data of the one or more webpage without the associated advertisements content to the mobile terminal, comprising:
causing to display by the mobile terminal: a calculation of reduction in traffic volume as a result of the filtering by the server, and a reminder to turn off filtering or turn on filtering in a new logging on.

8. A device for filtering mobile terminal webpage advertisements content, comprises at least a processor, processing functions in conjunction with:
a webpage access module, a sub-resource receiving module and an information display module, wherein:
the webpage access module sends a request to a server to request for visiting a website and for browsing one or more webpage,
the sub-resource receiving module receives from the server, after filtering advertisements content associated with the one or more webpage, a uniform resource locator (URL) list of sub-resource data of the one or more webpage, and requests for batch downloading from the server, the sub-resource data of the one or more webpage in the URL list, and
the information display module displays the sub-resource data of the one or more webpage for browsing.

9. The device according to claim 8, comprises:
a filtering decision module, which issues decision on whether the advertisements content associated with the one or more webpage need to be filtered or not, wherein:
if do not need to be filtered, the advertisements content associated with the one or more webpage will be returned by the server to the mobile terminal for browsing;
if need to be filtered, the advertisements content associated with the one or more webpage will not be returned by the server to the mobile terminal for browsing.

10. A server for filtering mobile terminal webpage advertisements content, comprises at least a processor, processing functions in conjunction with:
a webpage fetching module, an information filtering module and a webpage return module, wherein:
the webpage fetching acquisition module, in response to receiving a request from a mobile terminal to browse one or more webpage at a website, fetches the one or more webpage, acquires sub-resource data via analyzing the one or more webpage;
the information filtering module analyzes types of the sub-resource data of the one or more webpage, and filters advertisements content associated with the one or more webpage, using filtering rules which correspond to the sub-resource data types;
the webpage return module returns the sub-resource data from the one or more webpage together with a uniform resource locator (URL) list of the advertisements content associated with the one or more webpage to the mobile terminal, and in response to receiving a batch request to download the URL list of the sub-resource data from the one or more webpage, integrates the URL list of the sub-resource data as one or more webpage content; and returns the one or more webpage content to the mobile terminal for browsing.

11. The server according to claim 10, comprises:
a sub-resource determination module, in response to receiving the request from the mobile terminal to browse the one or more webpage at the website, determines whether the advertisements content exists in the one or more webpage;
if exists, the advertisements content is filtered via the information filtering module;
if does not exists, if advertisement content does not exist in the page resource content, returns the URL list of the sub-resource data from the one or more webpage to mobile terminal via the webpage return module.

12. The server according to claim 10, comprises:
a webpage layout module and a traffic volume calculation module, wherein:
the webpage layout module performs intelligent layout of the one or more webpage after advertisements content filtering, and
the traffic volume calculation module calculates traffic volume reduction resulting from the advertisements content filtering, and reminds a user of the mobile terminal via the information display module, to a reminder to turn off filtering or turn on filtering in a new logging on.

13. A system for filtering mobile terminal webpage advertisements contents, comprises a mobile terminal communicating to a server, wherein:
the mobile terminal makes a request to visit a website to browse one or more webpage via the server, makes a decision on whether or not to filter out advertisements content associated with the one or more webpage:
if yes, the server analyzes types of sub-resource data of the one or more webpage, filters out the advertisements content associated with the one or more webpage using filtering rules corresponding to the types of the sub-resource data of the one or more webpage, and returns only sub-resource data of the one or more webpage without the advertisement content to the mobile terminal.

14. The system according to claim 13, wherein the mobile terminal comprises a webpage access module and a filtering decision module:
the webpage access module is used to make a request for visiting a website for browsing one or more webpage via the mobile terminal browser;
the filtering decision module is used to make a decision on whether or not advertisements contents associated with the one or more webpage need to be filtered out: if yes, the advertisements content associated with the one or more webpage is filtered out via the server; if no the advertisements content associated with the one or more webpage are returned unfiltered to the mobile terminal via the server.

15. The system according to claim 14, wherein the mobile terminal comprises a resource receiving module and an information display module, wherein:
the resource receiving module is used to receive from the server, the sub-resource data of the one or more webpage, and make a batch request to the server to download the sub-resource data of the one or more webpage in a uniform resource locator (URL) list; and
the information display module is used to display:
the one or more webpage content having one or more prompting message which indicates filtered advertisements content; wherein the one or more prompting message enables browsing by the mobile terminal, only the filtered advertisements content as one or more new webpage,
a calculation of reduction in traffic volume as a result of the filtering by the server, and
a reminder to turn off filtering or turn on filtering in a new logging on.

16. The system according to claim 13, wherein the server comprises an information filtering module, a webpage return module, wherein:
the information filtering module is used to analyze types of sub-resource data of the one or more webpage, and filter the advertisements content associated with the one or more webpage using the filtering rules corresponding to the types of the sub-resource data of the one or more webpage; and
the webpage return module returns a URL list of the sub-resource data of the one or more webpage to the mobile terminal, and in response to receiving the batch request from the mobile terminal to download the URL list of the sub-resource data of the one or more webpage, integrate the URL list of the sub-resource data as one or more webpage content; and return the one or more webpage content to the mobile terminal for browsing.

17. The system according to claim 16, wherein the server comprises a webpage fetching module and a sub-resource determination module, wherein:
the webpage fetching module is used to fetch the one or more webpage, and acquire the sub-resource data of the one or more webpage via analysis of content of the one or more webpage;
the said sub-resource determination module is used to determine whether or not advertisements content exists in the content of the one or more webpage page:
if yes, the advertisement content is filtered out from the content of the one or more webpage page via the information filtering module;
if no, the advertisement content associated with the one or more webpage is returned unfiltered via the webpage return module.

18. The system according to claim 17, wherein the said server comprises a webpage layout module and a traffic volume calculation module, wherein:
the webpage layout module is used to perform intelligent layout of the one or more webpage after filtering, and
the traffic volume calculation module is used to calculate the traffic volume reduction resulting from the filtering, and remind a user of the mobile terminal to turn off filtering or turn on filtering in a new logging on.
